(19) United States
(12) Patent Application Publication
(10) Pub. No.: US 2005/0061747 A1
(43) Pub. Date: Mar. 24, 2005

(54) Flow-through fluidized filter tubes for water treatment

(76) Inventor: Roy Lawson Bowers, Verdi, NV (US)

Correspondence Address: Roy Bowers, P.O. Box 830, Verdi, NV, 89439, US

(21) Appl. No.: 10/669,874

(22) Filed: Sep. 23, 2003

(51) Int. Cl. C02F 1/42

(52) U.S. Cl. 210/681; 210/266

(57) ABSTRACT

A filtration apparatus for water allows facile purification of water used, for example, for domestic housing, swimming pools and hot tubs. It includes an external substantially supported rigid course filter; allowing water to pass into the apparatus, an inner tube disposed within the rigid course filter and attached to the frame, forming a first annular volume between the rigid course filter and the inner tube, and having at least one portal to allow fluid to pass into a lower pooling volume, a permeable member covering the portal separating the lower pooling volume and the first annular volume, an amount of a bimetallic treatment composition held within the lower pooling volume, a compacted block of adsorbable impurity treatment media having a diameter less than the inner diameter of the inner tube forming a second annular volume, and an inner open cylindrical portion forming the inside surface of the second annular volume, and an exit portal for a fluid formed by the open cylindrical portion allowing a fluid passed through the apparatus to exit the apparatus. This invention also includes a method for purifying water using the apparatus described.

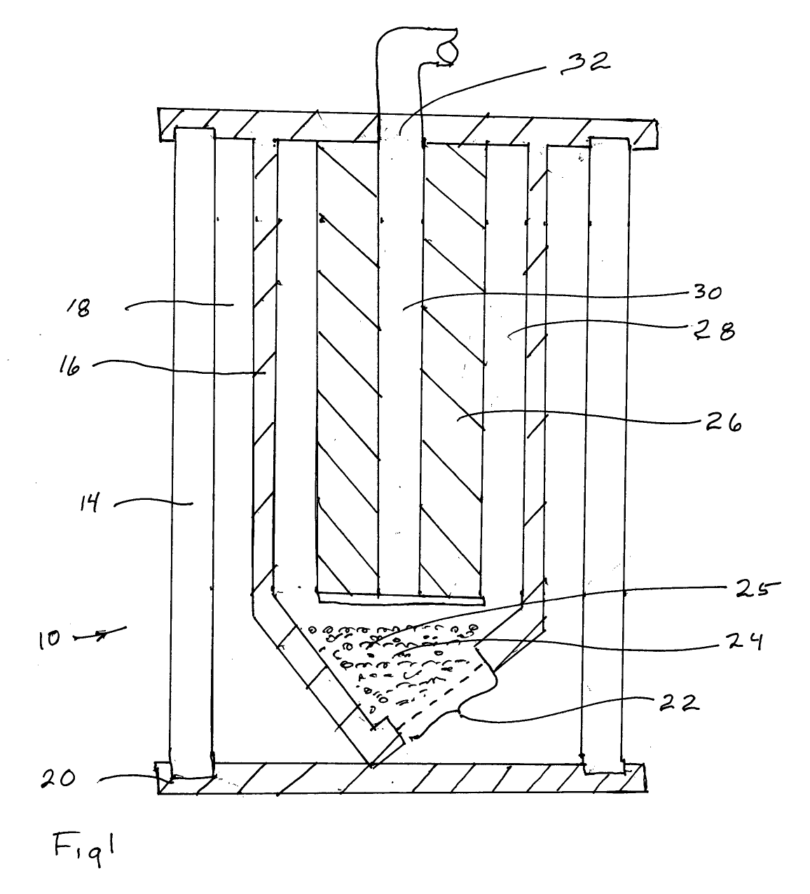

### BACKGROUND OF THE INVENTION

1. Field of the Invention

This invention relates to methods and apparatus for purifying water for personal or decorative uses; particularly, this invention relates to methods and apparatus for purifying water that will be used by people to contact their bodies or for drinking; and most particularly, this invention relates to methods of purifying water not involving addition of substantial amounts of dissolved chemicals in the water.

2. State of the Art

Most of the United States uses water from wells or water that is piped through old metal pipes. In either case, the water can become contaminated with a host of unwanted chemicals, minerals, and metals that can become dissolved in the water. Other ingredients are added by the water company. Such water tastes odd to most people when they drink it. Water can also have unwanted microbes in it, which have caused outbreaks of various diseases. These also should be removed.

A related problem is noticed by recreational users of hot tubs, spas, and whirlpool baths of various sorts, hereinafter generically referred to as hot tubs. At one time or another, most of the users notice the nearly universal problem of water quality affecting most hot tubs; that is, maintaining clear, sanitary and odor-free water after frequent uses.

Many solutions have been tried to maintain the water quality. One common method is the brute force method of adding large amounts of chlorine to the water. This tends to impart a distinct chlorine odor, an odor so bad that it can, at times, be strong enough to cause mild respiratory distress. Moreover, in the case of hot tubs and similar situations susceptible of multiple additions of chlorine, the amount of chlorine compounds dissolved in the water after frequent additions tend to become so concentrated that periodically all of the water in the hot tub must be replaced.

Other methods involve the pumping of large amounts of water to flow downwardly through beds of chemicals that perform various activities to purifying the water, primarily, various types of filtrations, to the water. These methods involve pumping the water through piping that must be built in the water circulating system of the hot tub and place additional burdens on the pumping system of the hot tub.

One solution that is recommended is passing the water through a stationary bed of a bimetallic alloy that participates in oxidation/reduction reactions as the water passes through. If a bed is to work, large amounts of the alloy must be used to purify the water, and the alloy must be periodically cleaned by passing the water upwardly through the bed.

Among other various methods that have been suggested to solve these problems, one of these methods involves a canister divided into several potions, each with a different granular material known to help with the purification of water. For example, one of these suggested methods and apparatus includes a cannister with KDF, carbon granules, and zeolite. The problem observed with these methods and apparatus is that the zeolite and the carbon tend to disintegrate in the cannister, sometimes to the extent that fine particles of the granular materials find their way into the final water stream.

### SUMMARY OF THE INVENTION

This invention provides a filtration apparatus for water and allows facile purification of water used, for example, for domestic housing, swimming pools and hot tubs. It includes an external substantially supported rigid course filter; allowing water to pass into the apparatus, an inner tube disposed within the rigid course filter and attached to the frame, forming a first annular volume between the rigid course filter and the inner tube, and having at least one portal to allow fluid to pass into a lower pooling volume, a permeable member covering the portal separating the lower pooling volume and the first annular volume, an amount of a bimetallic treatment composition held within the lower pooling volume, a compacted block of adsorbable impurity treatment media having a diameter less than the inner diameter of the inner tube forming a second annular volume, and an inner open cylindrical portion forming the inside surface of the second annular volume, and an exit portal for a fluid formed by the open cylindrical portion allowing a fluid passed through the apparatus to exit the apparatus. This invention also includes a method for purifying water using the apparatus described.

A first aspect of this invention is an apparatus for fluid treatment comprising:

an external substantially supported rigid course filter forming a outer surface of the filtration allowing a fluid to pass into the apparatus;

an inner tube disposed within the rigid course filter, the inner tube not being permeable to a fluid, the inner tube having a different diameter than the rigid course filter, forming a first annular volume between the rigid course filter and the inner tube, the inner tube having at least one portal to allow fluid to pass into a lower pooling volume;

a first end cap attached to the lower end of the inner tube, and receiving the rigid course filter;

a second end cap attached to the upper end of the inner tube and receiving the inner course filter, one of the first end cap and the second end cap having an exit portal for fluid defined therein;

a permeable member covering the at least one portal separating the lower pooling volume and the first annular volume;

an amount of a bimetallic treatment composition held within the lower pooling volume, the amount of bimetallic treatment composition being enough to provide sufficient volume to allow fluidization of the bimetallic treatment composition when a fluid is passed upwardly through the water treatment composition;

a compacted block of adsorbable impurity treatment media having a diameter less than the inner diameter of the inner tube forming a second annular volume, and an inner open cylindrical portion forming the inside surface of the second annular volume attached to the second end cap above the pooling volume, which can allows a fluid be fluidized around it and allows the fluid to pass through it; and,

an exit portal for a fluid formed by the open cylindrical portion allowing a fluid passed through the apparatus to exit the apparatus.

A second aspect of this invention is a method for filtering water, comprising:

passing water through an external substantially supported rigid course filter into a first annulus formed between the rigid course filter and an inner tube;

passing the water in the inner tube down the inner tube to a portal formed within the inner tube covered by a permeable member,

passing the water through a permeable member covering the portal separating the lower pooling volume and the annular volume;

forcing the water up through an amount of a bimetallic treatment composition held within a lower pooling volume thereby fluidizing the bimetallic treatment composition within a second annular volume;

passing the water through a compacted block of adsorbable impurity treatment media having an inner open cylindrical portion; and,

allowing the water to pass through an exit portal.

### DESCRIPTION OF THE DRAWINGS

The FIGURE shows a cutaway perspective views of one aspect of the present invention.

### DETAILED DESCRIPTION OF THE PREFERRED EMBODIMENT

Referring now to the appended FIGURE, a filtration apparatus 10 of the present invention includes an external substantially supported rigid course filter 14. In general, the substantially supported rigid filter will be non-woven fiber, such as paper, or plastic fibers or foam rubber disposed in a mat or similar type structure. The exterior may be smooth as shown, or it may be folded to increase the external surface area of the filter. The external filter may have enough structural strength to support itself, or it may be supported by an interior wall 14 that is water permeable.

Disposed within the filter will be an inner tube 16. The inner tube will have a diameter less than that of the course filter and the Pap between the two define an annulus 18. The inner tube is water impermeable. Water that passes through the course filter and flows downwardly toward the first end cap 20. Near the first end cap is at least one portal 22 cut into the inner tube. The portal is covered by a water permeable member, which can be screening material, made of metal, plastic, fabric, both woven and non-woven, and the like.

The water enters a pooling volume 24. Within the pooling volume is an amount of bimetallic granules held within. The incoming water flows upwardly, and the upwardly flowing water fluidizes the granules 25, shown in the FIGURE in a non-fluidized bed, in the second portion of the canister. The granular particles are bimetallic alloys, usually copper and zinc alloys. It will be seen in the FIGURE that the shape of the pooling volume is preferably conical, with the narrow end of the conical shape pointing downward. However, the shape may be conical or cylindrical or other appropriate volume. There may be one, two, three or four portals, or any other number that is appropriate.

Above the pooling zone is a compacted block of adsorbable impurity treatment media 26 having a diameter less than the inner diameter of the inner tube. Between the inside surface of the inner tube and the compacted block of absorbable impurity treatment media is a second annular volume 28. The fluidized granules can freely rise into the second annular volume. The water can then pass through the permeable wall of the compacted block and impurities and dissolved material can be adsorbed by the material of the block. The inside of the compacted block defines an inner open cylindrical portion 30. The water passes into the inner open cylindrical portion and flows to the exit portal 32.

The carbon block, especially hen impregnated with zeolite remains in one piece. This prevents the formation of fine particles that might otherwise find their way into the final water stream. The filtration and treatment qualities of the carbon block is as good or better than those properties in the granular materials. This allows the water to be treated in a superior a to the present methods and apparatus, and produces a cleaner, better filtered and treated product stream of water.

The exit portal can be defined in the first or the second end cap. If it is in the second end cap, as shown in the FIGURE, the water flows out of the top of the apparatus and to the eternal water system. If the exit portal is in the first end cap, a tube must be provided through the pooling volume to the exit portal.

The permeable material is screen material normally used in the top of purification units. The upward flow of the water through the bimetallic media will be of sufficient force to lift at least some of the media, but not cause violent surging of the media. This insures that the bimetallic alloy will not clump together as it starts to react with constituents of the water flowing upward past the fluidized bed of particles. If the water flow is to high, the effectiveness of the water treatment will be degraded, but such high flow rates may be required in some applications such as in a hot tub. In that case, the most effective purification occurs when the tub is in the slow filtration mode typical of when the hot tub is not being used. It will be noticed that any particles larger than 250μ will typically be stopped by this screen if they pass the course filter.

The water passes through the course filter media. It then passes to a water pooling portion, and then alone the bottom of the canister to a water permeable portion where the water can move upwardly through the fluidized media.

It should be noted that since the fluidization effect requires a correct orientation to gravity, this embodiment requires that the canister be mounted correctly, which is vertical.

The filter tubes of the present invention may be used in hot tubs and swimming pools as a replacement for the filter tubes normally used in those hot tubs and swimming pools. As such, the tubes need to be custom made to fit the various models and types of filter tubes no in use for this purpose, but, except for the contents of the tubes of this invention the tubes are the same size and fit in the same place as the conventional tubes now used. The tubes of the present invention treat the water effectively, in contrast to conventional tubes merely filter the water to remove the coarser particles found in the water. The tubes of the invention condition the water and allow for one tube to substantially purify and condition the water for use without the addition of other chemicals or other further processing. Importantly, the fluidization effect found within the tubes cleans and conditions the various media found within the tubes, and automatically keeps the conditioning media in optimum shape for conditioning the water. Moreover, the tubes of the present invention are not permanent fixtures. That is to say, after some period of time, perhaps a period of three months to a year, the tubes will cease to have suitable treating power and should be replaced.

The compacted block will usually be compacted granulated activated carbon, such as that sold by Calgon Carbon Corporation, Pittsburgh, Penn., under the trade name “Centaur granulated activated carbon.” The compact block adsorbs organic components in the water in the hot tub. Examples of organic constituents of the water include oils washed off the body, degradation products of cells, suntan lotion, and other objectionable fluids and dissolved solids. It also clarifies and decolorizes the water.

The granular alloy can be a bimetallic alloy such as any copper alloy, such as with tin, and silver, but the preferred alloy is one made of copper and zinc. It should be noted that certain alloys, such as those of lead and mercury are to be avoided because of the risk of toxicity of the alloys. The alloy may also be made of copper. Such alloys are sold under the brand names of, for example, BIRM and Pyrolox. The alloy interacts with the components of the water and participates in a variety of redox reactions with the components. It provides many benefits to the overall operation of the system. It removes free chlorine from the water by reducing it to the chloride ion which is unobjectionable in solution, and which may bind the chloride to the metal alloy particles. It reacts with the oxygen levels and the soluble ferrous ions to precipitate ferric hydroxide and inhibit the growth and proliferation of iron metabolizing bacteria. The metals used can be copper and zinc, the most preferred, or copper and silver, or magnesium and copper, or similar dissimilar types of metals. KDF Fluid Treatment, Incorporated, Three Rivers, Mich., sells a particularly preferred granulated alloy under the name KDF 55.

The compacted block may also contain zeolite. This zeolite may be one selected from the group consisting of the naturally occurring zeolites, such as, chabatite, mordenite, erionite, faujasite, and clinoptilolite, and synthetic zeolites such as ZSM-5. One particularly preferred material is sold under the name of Clinolite. In the system as herein described it functions primarily to remove ammonia from the water.

In a closed system, such as a hot tub or a swimming pool, the water is filtered and returned back to the hot tub via the return pipe. A pump propels the water through the circuit. However, in an open system, such as that in a domestic or commercial water softening application, the flow of the water is pushed by the local water pressure.

The pH of the water used using this invention will be between about five and nine, preferably between about 6.5 and 8.5, and most preferably between about 7.2 and 7.8. If the pH is balanced by conventional means, by the addition of hydrochloric or muriatic acid (HCl) and sodium bicarbonate (Na₂CO₃) or other conventional pH adjusting means. Although it is preferred that the water have as little calcium dissolved therein as possible; preferably the water will contain no more than between about zero to three hundred parts per million (ppm), preferably between about zero to two hundred ppm, and most preferably between about zero to one hundred fifth ppm calcium hardness.

The alloy of metals tends to eliminate the any free molecular chorine in the water, although with the use of this invention to provide water for hot tubs and the like, this is less of a problem since chlorine need not be used to purify the water.

With the use of the invention the water in hot tub need not be emptied because there is no chlorine. If the TDS level gets up too high the water may be drained, but if the TDS levels are watched the tub may never need draining in the ordinary course of usage.

This invention has been described b reference to specific embodiments and examples of those embodiments. Those having the usual level of skill in this art have the necessary skills and talents to modify, alter, and vary the embodiments, and the examples thereof shown herein, without straying from the essential nature of this invention. Therefore, the appended claims are intended to include all such modifications, alterations, and variations.

1. An apparatus for fluid treatment comprising:
an external substantially supported rigid course filter forming a outer surface of the filtration allowing a fluid to pass into the apparatus;
an inner tube disposed within the rigid course filter, the inner tube not being permeable to a fluid, the inner tube having a different diameter than the rigid course filter, forming a first annular volume between the rigid course filter and the inner tube, the inner tube having at least one portal to allow fluid to pass into a lower pooling volume;
a first end cap attached to the lower end of the inner tube, and receiving the rigid course filter;
a second end cap attached to the upper end of the inner tube and receiving the inner course filter, one of the first end cap and the second end cap having an exit portal for fluid defined therein.
a permeable member covering the at least one portal separating the lower pooling volume and the first annular volume;
an amount of a bimetallic treatment composition held within the lower pooling volume, the amount of bimetallic treatment composition being enough to provide sufficient volume to allow fluidization of the bimetallic treatment composition when a fluid is passed upwardly through the water treatment composition;
a compacted block of adsorbable impurity treatment media having a diameter less than the inner diameter of the inner tube forming a second annular volume, and an inner open cylindrical portion forming the inside surface of the second annular volume attached to the second end cap above the pooling volume, which can allow a fluid be fluidized around it and allow the fluid to pass through it; and
an exit portal for a fluid formed by the open cylindrical portion allowing a fluid passed through the apparatus to exit the apparatus.

2. The filtration apparatus of claim 1 wherein the bimetallic treatment is selected from bimetallic alloys including copper.

3. The filtration apparatus of claim 1 wherein the compacted block of adsorbable impurity treatment media includes charcoal particles.

4. The filtration apparatus of claim 3 wherein the compacted block of adsorbable impurity treatment media further includes compacted zeolite.

5. The filtration apparatus of claim 2 herein the binary alloy of copper is an alloy of between 20 and 80 weight percent copper and between 80 and 20 weight percent zinc.

6. The filtration apparatus of claim 1 wherein the flow of water upwardly is between about 0.5 to 5 gallons of after per pound of bimetallic treatment per minute.

7. The filtration apparatus of claim 4 wherein the zeolite is selected from the group consisting of chabatite, mordenite, erionite, faujasite, clinoptilolite, and ZSM-5.

8. The filtration apparatus of claim 1 wherein the filtration apparatus is mounted vertically top allow fluidization of media inside the apparatus.

9. A method for filtering water comprising:
passing water through an external substantially supported rigid course filter into a first annulus formed between the rigid course filter and an inner tube;
passing the water in the inner tube down the inner tube to a portal formed within the inner tube covered by a permeable member,
passing the water through a permeable member covering the portal separating the lower pooling volume and the annular volume;
forcing the water up through an amount of a bimetallic treatment composition held within a lower pooling volume thereby fluidizing the bimetallic treatment composition within a second annular volume;
passing the water through a compacted block of adsorbable impurity treatment media having an inner open cylindrical portion, and
allowing the water to pass through an exit portal.

10. The method of claim 9 wherein the bimetallic treatment is selected from the group consisting of bimetallic alloys and copper alloys, charcoal particles and granular zeolite.

11. The filtration apparatus of claim 9 wherein the bimetallic treatment is selected from bimetallic alloys including copper.

12. The filtration apparatus of claim 9 wherein the compacted block of adsorbable impurity treatment media includes charcoal particles.

13. The filtration apparatus of claim 12 wherein the compacted block of adsorbable impurity treatment media further includes compacted zeolite.

14. The filtration apparatus of claim 13 wherein the binary alloy of copper is an alloy of between 20 and 80 weight percent copper and between 80 and 20 weight percent zinc.

15. The filtration apparatus of claim 14 wherein the flow of water upwardly is between about 0.5 to 5 gallons of water per pound of bimetallic treatment per minute.
